(19) United States
(12) Patent Application Publication
(10) Pub. No.: US 2026/0252079 A1
(43) Pub. Date: Aug. 27, 2026

(54) SYSTEM AND METHOD FOR UTILIZING LARGE LANGUAGE MODELS IN ADVANCED AIR MOBILITY

(71) Applicant: ELECTRONICS AND TELECOMMUNICATIONS RESEARCH INSTITUTE, Daejeon (KR)

(72) Inventor: Daegyu LEE, Daejeon (KR)

(21) Appl. No.: 19/245,036

(22) Filed: Jun. 20, 2025

(30) Foreign Application Priority Data
Jun. 20, 2024 (KR) 10-2024-0080102
Jun. 20, 2025 (KR) 10-2025-0081483

(51) Int. Cl. G05D 1/229; G05B 13/02; G05D 1/622; G05D 101/15; G05D 109/20; G08G 5/25; G08G 5/80

(52) U.S. Cl. CPC G05D 1/229; G05B 13/027; G05D 1/622; G08G 5/25; G08G 5/80; G05D 2101/15; G05D 2109/20

(57) ABSTRACT

Disclosed are a system and method using a large language model for aerial mobility means. The system using a large language model for aerial mobility means includes an air mobility configured to transmit flight information and a server configured to receive the flight information, determine whether a collision risk is present in the air mobility by performing analysis using an LLM, and transmit order information based on the results of the determination.

### TECHNICAL FIELD

The present disclosure relates to a system and method using a large language model for aerial mobility means. The present disclosure has been derived based on the results of the execution of a project “Overview of Development for UAM Surveillance Information Acquisition and Fusion” (24IR7200) of Electronics and Telecommunications Research Institute.

### RELATED ART

Urban air mobility (UAM) and advanced air mobility (AAM) are developed with the aim of reduced traffic congestion and logistics innovation through a short flight within a downtown area. As a fully autonomous flight and a high-density flight are expected in the future, the advancement of the UAM and the AAM is required from the viewpoint of various factors, such as flight planning, route sharing, collision evasion, and passenger safety management.

However, aerial mobility means has a problem in that it is difficult to directly mount a large language model (LLM) having strength in an artificial intelligence-based automation decision system, in particular, the processing of a natural language, on the aerial mobility means because the aerial mobility means has limits in view of its size, weight, power, and cost (SWaP-Cost).

### SUMMARY

### Problem to be Solved

Various embodiments are directed to providing a system and method using a large language model (LLM), which interpret and determine information by using an LLM based on flight path and behavior planning information of the body of aerial mobility means and a ground communication device and the transmission and reception of approval/adjustment information and satisfy flight safety and flight standards.

### Solution to Problem

A system using a large language model (LLM) for aerial mobility means according to an embodiment of the present disclosure includes an air mobility configured to transmit flight information and a server configured to receive the flight information, determine whether a collision risk is present in the air mobility by performing analysis using an LLM, and transmit order information based on the results of the determination.

The air mobility transmits the flight information including trajectory information including latitude, longitude, altitude, and time information and flight plan information.

The air mobility transmits the flight plan information including a planned altitude, direction, and speed.

The air mobility transmits flight information of another mobility, which is received through direct communication between air mobilities.

The server includes a prompt conversion unit configured to perform prompt engineering based on the flight information, a large language model (LLM) processing unit configured to determine whether a collision possibility is present by providing a generated prompt to the LLM, a collision evasion decision unit configured to determine the subject of evasion based on the results of a determination of the LLM, an evasion path calculation unit configured to calculate a path for the determined subject of evasion, and an order transmission unit configured to transmit the path to the air mobility.

The prompt conversion unit converts the flight information into a natural language sentence having a contextual structure, which is understandable by the LLM.

The LLM processing unit determines the suitability of a flight plan by previously learning aviation safety regulations.

The collision evasion decision unit determines the subject of evasion by considering a priority rule.

The collision evasion decision unit calculates evasion priority by considering at least any one of importance of a flight mission, a remaining battery capacity, a flight speed, and a communication state.

The evasion path calculation unit generates an alternative flight path including at least any one of altitude, direction, and speed based on a minimum risk maneuvering strategy.

The order transmission unit transmits information that approves a flight plan included in the flight information received from the air mobility or adjustment information on the flight path.

A method of using a large language model (LLM) for aerial mobility means according to an embodiment of the present disclosure includes (a) receiving flight information from an air mobility, (b) performing prompt engineering based on the flight information and generating a query for an LLM, (c) determining an evasion of the air mobility by using the LLM, and (d) calculating an evasion path of the air mobility and transmitting orders.

The step (a) includes receiving trajectory information including latitude, longitude, altitude, and time information.

The step (b) includes converting the flight information into a natural language sentence.

The step (c) includes determining the suitability of the flight information based on the results of learning of aviation safety regulations and determining the air mobility to be the subject of evasion by considering a priority rule.

The step (c) includes determining the evasion of the air mobility by considering the priority rule including at least any one of importance of a flight mission, an amount of remaining battery power, a flight speed, and a communication state.

The step (d) includes calculating an evasion path including at least any one of altitude, direction, and speed based on a minimum risk maneuvering strategy.

An apparatus for using a large language model for aerial mobility means according to an embodiment of the present disclosure includes an input interface device configured to receive flight information of an air mobility, memory in which a program that determines whether a collision possibility is present by analyzing the flight information by using an LLM has been stored, and a processor configured to execute the program. The processor generates modified information on the approval of flight plan information included in the flight information or the flight plan information.

The processor determines whether the air mobility corresponds to the subject of evasion by considering a priority rule.

The processor generates an alternative flight path including at least any one of altitude, a direction, and a speed when the air mobility corresponds to the subject of evasion by considering the priority rule including at least any one of importance of a flight mission, an amount of remaining battery power, a flight speed, and a communication state and transmits the modified information.

### Advantageous Effects of Invention

According to embodiments of the present disclosure, it is possible to analyze and determine whether multiple aerial mobility means can safely fly within the same airspace in real time based on trajectory information (or intent information) received through communication between aircrafts, in particular, a four-dimensional (4-D) trajectory information (e.g., latitude, longitude, altitude, and time). Accordingly, it is possible to overcome the limit of human resources and to maximize flight efficiency because a conventional flight plan review and collision evasion decision work that is performed through a pilot or ground control personnel is automated based on a large language model.

In a current air mobility ecosystem in an initial stage in which technical standards and legislations are incomplete, although multiple aircrafts fly in an environment in which different institutions and businesses are associated, a basis for determination can be generated by integrating and analyzing data in a way to comply with manual and aviation safety standards according to an embodiment of the present disclosure. It is possible to implement an intelligent operation system capable of a manual-based consistent determination and approval/adjustment not a human resources-based subjective operation.

According to an embodiment of the present disclosure, in an aerial mobility means body environment in which it is difficult to directly mount high performance AI due to the SwaP-C limit, it is possible to provide a technical base that stably supports operation standard compliance verification, a collision evasion intention determination, and communicate-based collaborative navigation technologies that are essential in a high-density autonomous flight operation because a large language model is effectively used based on an association structure between an aircraft and a ground server.

Effects of the present disclosure which may be obtained in the present disclosure are not limited to the aforementioned effects, and other effects not described above may be evidently understood by those skilled in the art from the following description.

### BRIEF DESCRIPTION OF THE DRAWINGS

FIG. 1 illustrates a system using a large language model for aerial mobility means according to an embodiment of the present disclosure.

FIG. 2 illustrates a construction of an air mobility according to an embodiment of the present disclosure.

FIG. 3 illustrates a construction of a server according to an embodiment of the present disclosure.

FIG. 4 illustrates an example of a modified path for an evasion flight based on a collision possibility according to a randomly generated path according to an embodiment of the present disclosure.

FIG. 5 illustrates a method of using a large language model for aerial mobility means according to an embodiment of the present disclosure.

FIG. 6 is a block diagram illustrating a computer system for implementing a method according to an embodiment of the present disclosure.

### DETAILED DESCRIPTION

The aforementioned object, other objects, advantages, and characteristics of the present disclosure and a method for achieving the objects, advantages, and characteristics will become clear with reference to embodiments to be described in detail along with the accompanying drawings.

However, the present disclosure is not limited to embodiments disclosed hereinafter, but may be implemented in various different forms. The following embodiments are merely provided to easily notify a person having ordinary knowledge in the art to which the present disclosure pertains of the objects, constructions, and effects of the present disclosure. The scope of rights of the present disclosure is defined by the writing of the claims.

Terms used in this specification are used to describe embodiments and are not intended to limit the present disclosure. In this specification, an expression of the singular number includes an expression of the plural number unless clearly defined otherwise in the context. The term “comprises” and/or “comprising” used in this specification does not exclude the presence or addition of one or more other components, steps, operations and/or components in addition to mentioned components, steps, operations and/or components.

Hereinafter, in order to help understanding of those skilled in the art, a proposed background of the present disclosure is described and embodiments of the present disclosure are then described.

In urban air mobility (UAM) and advanced air mobility (AAM), a flight is basically performed within a downtown area. The UAM and the AAM are developed with the aim of reduced traffic congestion and logistics innovation. Accordingly, essential factors, such as flight planning, the sharing of a path, real-time health monitoring, collision evasion, and passenger safety management, are required for the UAM and the AAM. In particular, in the medium and long term, after the year 2030, a fully autonomous flight and high-density flight environment is expected. The development of technologies for the fully autonomous flight and high-density flight environment is essential.

Conventionally, an airplane pilot or a ground controller manually review operation standards and perform a collision evasion decision. However, in a flight operation environment in which multiple mobilities cooperate with each other in real time, a human resource-based operation is at its limit. In order to solve such a problem, an artificial intelligence (AI)-based automated decision system is required. In particular, the use of a large language model (LLM) having an excellent ability to process a natural language and interpret a document is in the spotlight.

However, in the air mobility, it is difficult to mount a high performance LLM due to the limits of size, weight, power, and cost (SWaP-Cost). In order to solve such a problem, a hybrid processing structure in which communication between aircrafts and a ground server are associated is required.

Embodiments of the present disclosure have been proposed based on the ideas of the aforementioned background, and are directed to providing a system and method using an LLM, which can interpret and determine information and satisfy flight safety and flight standards by using an LLM through the transmission and reception of flight plan information and approval/adjustment information of an air mobility and a server.

Embodiments of the present disclosure are directed to efficiently processing flight path and behavior planning information that is received through communication between aircrafts in AAM or UAM, and relate to a system and method which interpret received information and satisfy flight safety and flight standards by using an LLM.

According to an embodiment of the present disclosure, four-dimensional (4-D) trajectory plan information (e.g., latitude, longitude, altitude, and time) that is transmitted by an air mobility is connected. A safe evasion path is provided by determining a collision possibility between a plurality of mobilities or between an air mobility and urban infrastructure in real time based on the 4-D trajectory plan information.

According to an embodiment of the present disclosure, the suitability of a received flight plan is automatically reviewed based on aviation safety standards and manuals, such as RTCA and FAA. Safe evasion path information is provided to each air mobility based on the results of the review. RTCA regulates a minimum operation performance criterion for a collision prevention system, and regulates a minimum separation criterion related to vertical and horizontal distances for collision prevention. For example, the standard vertical separation criterion may be 500 feet, and the standard horizontal separation criterion may be regulated based on the altitude and speed of an air mobility. FAA regulates a separation criterion in the air information manual and the commands for air traffic control. In FAA, 1,000 feet in flight altitude of 290 or more and 2,000 feet in less than flight altitude of 290 are regulated as the vertical separation criterion between mobilities. The horizontal separation criterion may be differently regulated depending on the type of the airspace and a monitoring method (e.g., radar or ADS-B).

According to an embodiment of the present disclosure, it is possible to efficiently use an LLM through association between an air mobility and a ground server. If multiple air mobilities fly in the same corridor, it is possible to integrally analyze information of the multiple air mobilities and to establish a flight plan and a collision evasion strategy.

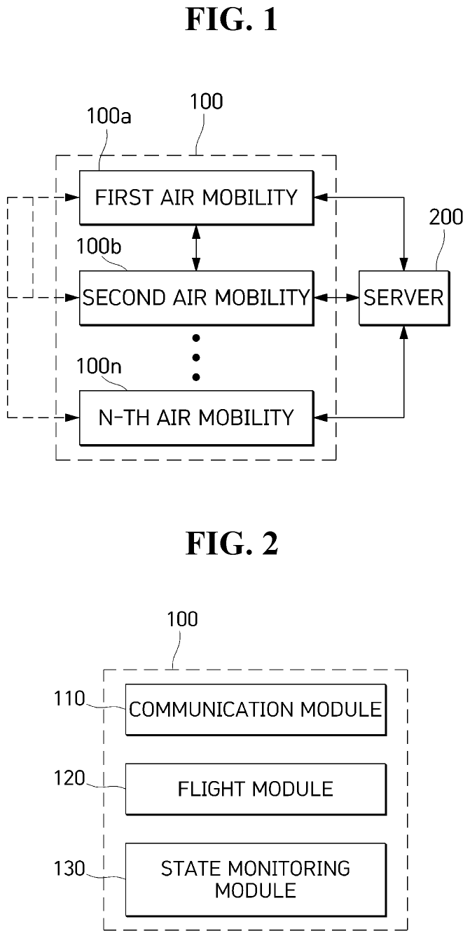

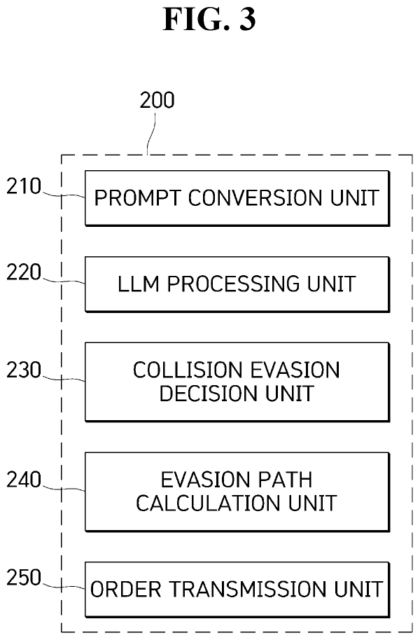

FIG. 1 illustrates a system using an LLM for aerial mobility means according to an embodiment of the present disclosure. FIG. 2 illustrates a construction of an air mobility according to an embodiment of the present disclosure. FIG. 3 illustrates a construction of a server according to an embodiment of the present disclosure.

The system using an LMM for aerial mobility means according to an embodiment of the present disclosure includes multiple air mobilities 100-1, 100-2 to 100-n and a server 200 that operate in conjunction with the multiple air mobilities. The air mobility 100 includes a communication module 110, a flight module 120, and a state monitoring module 130. The server 200 includes a prompt conversion unit 210, an LLM processing unit 220, a collision evasion decision unit 230, an evasion path calculation unit 240, and an order transmission unit 250.

The air mobility 100 is an aircraft capable of an autonomous or semi-autonomous flight, and transmits flight information to the server 200 in real time through the communication module 110. The flight information includes 4-D trajectory information, including latitude, longitude, altitude, and time information, and flight plan information. The flight plan information means information on future flight behaviors, such as a planned altitude, direction, and speed.

The server 200 belongs to a transportation service provider or a transportation management system, and integrates and manages flight information received from the plurality of air mobilities 100. The server 200 structures received raw data through prompt engineering, determines the suitability of a flight plan by using an LLM, and generates approval information on flight plan information of the air mobility 100 or evasion path information (i.e., adjustment information on flight plan information of the air mobility 100) for collision evasion.

The approval information or the evasion path information is transmitted from the server 200 to the air mobility 100. When receiving the approval information, the air mobility 100 continues to fly based on flight plan information that was previously planned and transmitted to the server 200. When receiving the evasion path information, the air mobility 100 modifies flight plan information and flies based on the modified flight plan information.

Behavior planning information including location, speed, altitude, and time information can be transmitted and received between different air mobilities within a preset communication distance. For example, behavior planning information can be transmitted and received between the first air mobility 100a and the second air mobility 100b. In this case, at least any one of the first air mobility 100a and the second air mobility 100b may also transmit behavior planning information to the other of the first air mobility 100a and the second air mobility 100b in addition to the transmission of its own behavior planning information to the server 200. For example, the first air mobility 100a supports behavior planning retention or modification of the second air mobility 100b by transmitting its own behavior planning information and behavior planning information of the second air mobility 100b to the server 200, maintaining or modifying the existing behavior planning based on approval/adjustment information received from the server 200, and transferring approval/adjustment information of the second air mobility 100b, which is received from the server 200, to the second air mobility 100b. For example, it is assumed that communication between the first air mobility 100a and the second air mobility 100b is not limited and communication between the second air mobility 100b and the server 200 is not smooth because the second air mobility 100b is placed in a specific shadow area. In this case, the first air mobility 100a transfers approval or the adjustment information on flight plan information of the second air mobility 100b by playing a role as a gateway between the second air mobility 100b and the server 200. As another example, the first air mobility 100a may transmit flight plan information according to a minimum risk strategy to the second air mobility 100b through a separate emergency communication channel or may transfer flight plan information according to a minimum risk strategy that is received from the server 200 to the second air mobility 100b.

Referring to FIG. 2, the air mobility 100 includes the communication module 110, the flight module 120, and the state monitoring module 130.

The communication module 110 performs the transmission and reception of information between the air mobility and the server, and transmits and receives information to and from the server or an adjacent air mobility in real time through various wireless protocols, such as DSRC, 5G-V2X, and Wi-Fi Direct.

Information that is transmitted by the air mobility includes location, altitude, speed, heading information, an expected path, and flight plan information.

The flight module 120 interprets orders (e.g., a behavior change, an evasion direction, and a wait command) received from the server 200, and transmits the orders to a flight control system. The flight module 120 is capable of a real-time autonomous determination, and may perform a fallback determination when communication with the server 200 is disconnected.

The state monitoring sensor 130 includes an IMU, a GPS, an altitude system, and an ADS-B receiver, and detects the mobility state of an air mobility and a surrounding flight. The state monitoring information is also used for an autonomous determination of the flight module 120.

Referring to FIG. 3, the server 200 includes the prompt conversion unit 210, the LLM processing unit 220, the collision evasion decision unit 230, the evasion path calculation unit 240, and the order transmission unit 250.

The prompt conversion unit 210 performs prompt engineering. In this case, the prompt engineering refers to processing for converting raw data (e.g., location, altitude, speed, and flight plan information) received from an air mobility into a query format that is suitable for the input format of a natural language or LLM having a contextual structure. That is, the prompt engineering refers to a technology in which information is refined and structured so that an LLM can accurately perform a determination based on regulations, such as FAA and RTCA. The prompt conversion unit 210 converts unstructured raw sensor data and a packet into a natural language and a structured query format. For example, the prompt conversion unit 210 automatically generates a query relating to whether there is a risk of a collision with a surrounding air mobility at the location X, altitude Y, and time T of an air mobility A and inputs the query to an LLM. For example, when raw data are {lat: 37.567, lon: 126.978, alt: 450 ft, time: 12:03:15, intent: ascend left}, the prompt conversion unit 210 converts the {lat: 37.567, lon: 126.978, alt: 450 ft, time: 12:03:15, intent: ascend left} into a prompt “Mobility A intends to ascend left starting from lat 37.567, lon 126.978 at 450 ft, time 12:03:15. Is this trajectory safe given mobility B's current path?”.

The LLM processing unit 220 receives data that are converted through prompt engineering, performs a determination, and performs a determination based on preset criterion (e.g., FAA/RTCA criteria). An LLM has a pre-learnt air transportation management manual and regulation information embedded therein, and determines a collision possibility between air mobilities or an air mobility and a surrounding object, and whether a separation criterion is satisfied.

The collision evasion decision unit 230 receives the results of a determination derived from an LLM, identifies a risk of a collision when the risk is present, and determines whether to take measures based on a priority rule. The collision evasion decision unit 230 precisely analyzes a collision possibility between a plurality of air mobilities or between an air mobility and urban infrastructure based on the data of the results of the determination received from the LLM processing unit 220. In this case, the collision evasion decision unit 230 determines whether to take evasion measures based on a multi-layer priority rule without being simply limited to a collision determination based on a distance criterion.

Specifically, the collision evasion decision unit 230 determines whether to take evasion measures by considering at least any one of the importance of a flight mission, flight altitude, the amount of remaining energy, a speed, maneuverability, an evasion path collision possibility, a priority entry ticket in a flight corridor, mobility reliability, and a communication state.

When considering the importance of a flight mission, the collision evasion decision unit 230 exempts an air mobility that performs a mission having high urgency, such as medical transfer, public safety, and a disaster response, from an evasion duty or minimizes the evasion duty. Information on the importance of a flight mission may include keywords, such as “emergency”, “medevac”, and “critical”, in its intent field. An LLM identifies the keywords.

When considering the flight altitude and the amount of remaining energy, the collision evasion decision unit 230 assigns evasion measures to an aircraft having relatively high altitude because the ascending space of an aircraft having low altitude is limited. Furthermore, the evasion flight of an aircraft having a small amount of remaining battery power is limited, and corresponding information may be obtained through the state monitoring module 130.

When considering the speed and maneuverability, the collision evasion decision unit 230 designates a relatively low-speed aircraft as an evasion subject because it is difficult for an aircraft being in a high-speed flight to make an immediate evasion flight. An LLM analyzes such speed information as a prompt-based query and then selects an evasionable candidate group.

When considering the evasion path collision possibility, the collision evasion decision unit 230 excludes corresponding evasion options from the priority if a new collision possibility with another object occurs due to evasion orders. The collision evasion decision unit 230 dynamically evaluates a risk of danger in an expected evasion path by cooperating with the evasion path calculation unit 240.

When considering the priority entry ticket within the flight air corridor, the collision evasion decision unit 230 assigns the right to maintain a path to an aircraft that first enters a specific airspace or air corridor, and the requests evasion from the aircraft. This is based on the airspace regulations and flight control priority rules of RTCA/FAA.

When considering the mobility reliability and the communication state, the collision evasion decision unit 230 excludes an aircraft having an unstable communication state or omitted state information from a manual evasion target. In this case, a counterpart aircraft performs active evasion.

As described above,, the collision evasion decision unit 230 performs multi-determination logic in which various factors, such as a mission priority, aircraft limits, and communicate reliability, have been integrated, without being limited to a determination of a distance criterion, and thus can establish a more precise situation-customized collision evasion strategy. The collision evasion decision unit 230 can digitize an evasion priority for each air mobility by applying a priority table or weighted scoring method according to circumstances. Such numerical values are generated based on metadata attached to the results of a determination calculated by an LLM.

The evasion path calculation unit 240 calculates a new evasion path for an air mobility having a collision possibility identified based on a minimum risk maneuvering (MRM) strategy. Upon calculation, performance limits of the air mobility, weather conditions, and surrounding infrastructure information are considered.

The order transmission unit 250 transmits the calculated evasion path or behavior orders to a target air mobility. The orders may include a behavior priority, limit altitude, and a limit path change range.

An embodiment of the present disclosure proposes a structure in which all of a real-time determination, a high-speed response, and the reliability of a central determination can be secured. In particular, there is an advantage in that the present disclosure is suitable for a high-density mobility flight environment at the heart of a city.

According to an embodiment of the present disclosure, an air mobility provides its future flight plan to an LLM as a query. In response thereto, the LLM generates collision evasion orders.

The server 200 performs the learning of UAM V2V white paper and Detect and Avoid aviation manual through text embedding or vectorization, and transmits a modified command (i.e., collision evasion orders) for the approval of a flight plan or the flight plan by using an LLM.

An air mobility transmits trajectory information including 4-D information of {latitude, longitude, altitude, and time} to an LLM in a natural language query form “This is my future trajectory”. The trajectory information is converted into a structured command which may be understood by the LLM through a prompt engineering process.

The LLM determines a collision possibility by comparing a path with the path of another aircraft that flies in the same corridor or time zone based on the prediction location of an aircraft included in the query. In the determination process, reference is made to the vertical and horizontal separation criteria defined in RTCA DO-382 and the flight level criterion of FAA.

For example, RTCA DO-382 requires 500 feet as a vertical separation criterion and 3 to 5 nautical miles as a horizontal separation criterion. According to the FAA regulations, the vertical separation of 1,000 feet in FL 290 (about 29,000 feet) or more and the vertical separation of 2,000 feet in less than FL 290 (about 29,000 feet) are required. The horizontal separation is different depending on a monitoring method (radar/ADS-B). According to the criteria, an LLM may present a path for evading a collision as follows. That is, the LLM increases the altitude of a first air mobility from a start waypoint (waypoint 1) by 2 feet, increases the longitude of the first air mobility by 0.0100 degree, and presents a path for a progress during 5 steps. Furthermore, the LLM decreases the altitude of a second air mobility by 2 feet from the same waypoint, identically increases the longitude of the second air mobility by 0.0100 degree, and presents a path for a progress during 5 steps. Such a response is a substantial collision evasion strategy that is derived by a natural language-based AI model. In a flight mobility traffic management system, corresponding orders are transferred to the autonomous flight module of an aircraft and are immediately executed. Furthermore, according to an embodiment of the present disclosure, characteristics of an LLM that performs a multi-layer determination by comprehensively considering state, priority (e.g., urgent transfer), and weather information of a plurality of air mobilities are incorporated, and are different from the existing rule-based system.

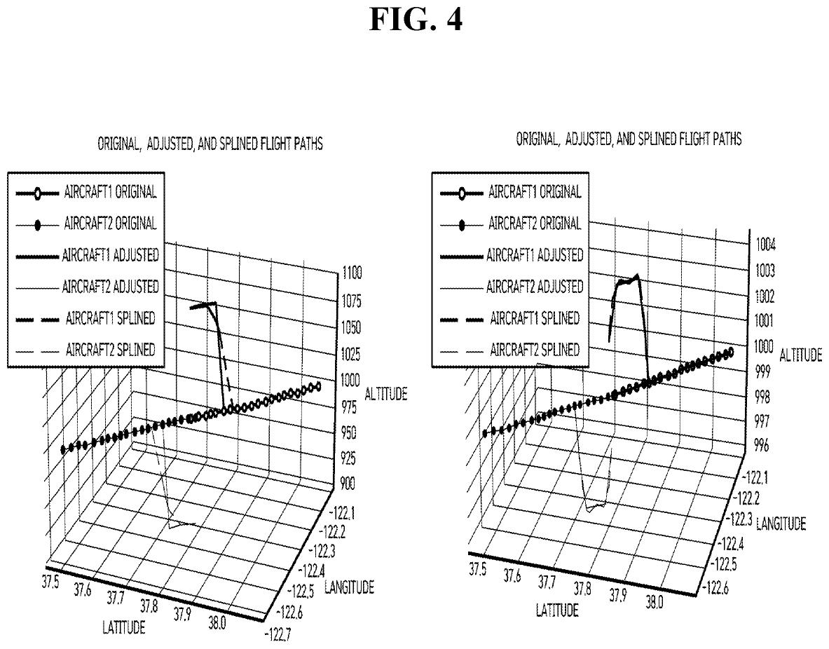

FIG. 4 illustrates an example of a modified path for an evasion flight based on a collision possibility according to a randomly generated path according to an embodiment of the present disclosure.

When a first air mobility Aircraft 1 and a second air mobility Aircraft 2 fly in opposite directions within the same flight air corridor, the server 200 determines evasion measures by calculating the prediction paths and expected collision timing of the two air mobilities.

For example, the server 200 determines evasion measures so that the first air mobility increases its altitude and the second air mobility decreases its altitude, and transmits the evasion measures to each of the air mobilities so that the flight paths of the two air mobilities are modified.

As another example, as described above, priority may be incorporated. For example, a scenario in which an LLM recognizes that the first air mobility has been classified as an emergency medical transport aircraft, maintains the flight path of the first air mobility based on a priority determination, and transmits evasion orders to the second air mobility may be constructed. In this process, upon prompt engineering, the first air mobility incorporates metadata indicating that the first air mobility is in emergency transport in its determination by converting the metadata in the form of letters which may be understood by the LLM. The second air mobility that receives evasion orders executes evasion according to internal determination logic, performs state monitoring in this process, and checks or confirms a surrounding obstacle or the location of another air mobility. After the evasion is completed, the server rearranges a flight path by changing the trajectory plan of a plurality of air mobilities through re-synchronization, and transmits approval information so that the plurality of air mobilities continues to fly.

According to an embodiment of the present disclosure, an evasion determination that is flexible and responds to a situation can be performed through a contextual-based multi-layer determination of an LLM not a fixed rule-based determination, and is different from the existing air transportation control system.

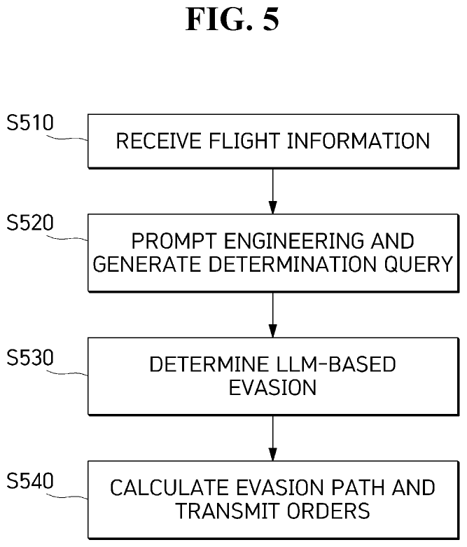

FIG. 5 illustrates a method of using a large language model for aerial mobility means according to an embodiment of the present disclosure. The method using an LLM for aerial mobility means according to an embodiment of the present disclosure includes a flight information reception step S510, a prompt engineering and determination query generation step S520, an LLM-based evasion determination step S530, and an evasion path calculation and order transmission step S540.

According to an embodiment of the present disclosure, the server on the ground determines the suitability of a corresponding flight plan by using an LLM based on behavior planning information/flight plan information received from a plurality of air mobilities, and provides evasion orders or a modified path if necessary.

In step S510, the server receives 4-D trajectory plan information ({latitude, longitude, altitude, and time}) from an air mobility. The 4-D trajectory plan information is periodically transmitted through the communication module of the air mobility, and includes information, such as the planned path, altitude change, direction, and speed of each air mobility. Furthermore, the 4-D trajectory plan information may also include third air mobility information that is indirectly collected by inter-mobility direct communication (V2V).

In step S520, the server converts the received unstructured data in the form of a query which may be processed by an LLM. Specifically, the server constructs a contextual prompt based on the 4-D trajectory and intent information of each air mobility so that the LLM can perform a determination based on preset criterions (i.e., the FAA/RTCA criterion). For example, the received unstructured data are converted in a format, such as “Aircraft A intends to ascend left from lat 37.567, lon 126.978 at 450 ft, time 12:03:15. Is this trajectory safe given Mobility B's current path?”.

In step S530, the server performs a determination based on the generated query, and evaluates whether the flight plan of a corresponding aircraft satisfies regulated separation criteria. When identifying that there is a collision risk based on the results of the determination, the server determines the subject of evasion based on priority criteria (e.g., the importance of mission, altitude, speed, and a communication state). In this case, the LLM also outputs a basis for determination (including metadata) in which the situation and priority of each air mobility have been considered.

In step S540, when determining that collision evasion is required, the server calculates a substitution path according to a minimum risk maneuvering (MRM) strategy, and transmits a modified flight plan information to a corresponding air mobility. The air mobility changes its path based on the received orders and continues to fly based on the modified plan.

According to an embodiment of the present disclosure, a situation-adaptive intelligence decision system different from the existing fixed rule-based collision evasion system can be realized by complexly considering the states, intent, interactions, communication possibilities, and outside infrastructure states of a plurality of air mobilities without being limited to a determination of a single aircraft. Furthermore, the speed and accuracy of a determination can be simultaneously secured compared to the existing system through the LLM-based decision-making structure. A stable traffic flow can be maintained even in a high-density flight environment at the heart of a city.

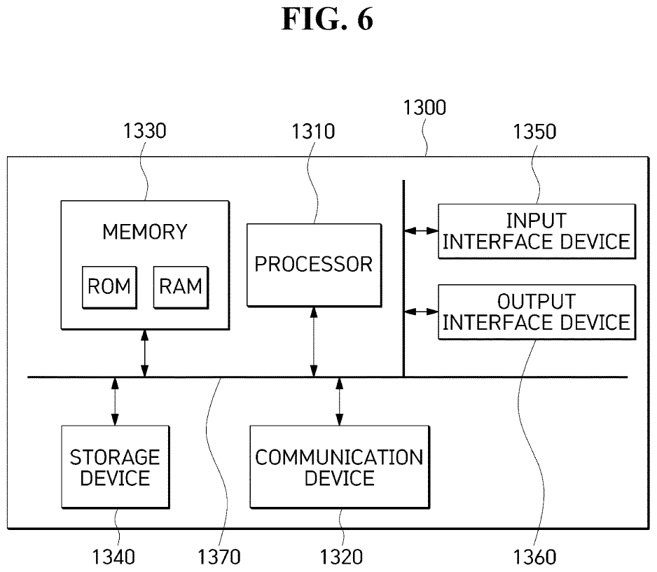

FIG. 6 is a block diagram illustrating a computer system for implementing a method according to an embodiment of the present disclosure.

Referring to FIG. 6, a computer system 1300 may include at least one of a processor 1310, memory 1330, an input interface device 1350, an output interface device 1360, and a storage device 1340 which communicate with each other through a bus 1370. The computer system 1300 may further include a communication device 1320 connected to a network. The processor 1310 may be a central processing unit (CPU), or may be a semiconductor device that executes instructions stored in the memory 1330 or the storage device 1340. The memory 1330 and the storage device 1340 may each include various types of volatile or nonvolatile storage media. For example, the memory may include read only memory (ROM) and random access memory (RAM). In an embodiment of the present disclosure, the memory may be disposed inside or outside the processor. The memory may be connected to the processor through various known means. The memory includes various types of volatile or nonvolatile storage media. For example, the memory may include read-only memory (ROM) or random access memory (RAM).

Accordingly, an embodiment of the present disclosure may be implemented as a method implemented in a computer or may be implemented as a non-transitory computer-readable medium in which a computer-executable instruction has been stored. In an embodiment, when being executed by the processor, a computer-readable instruction may perform a method according to at least one aspect of this writing.

An apparatus using an LLM for aerial mobility means according to an embodiment of the present disclosure includes the input interface device 1350 that receives flight information of an air mobility, the memory 1330 in which a program that determines whether there is a collision possibility by analyzing flight information by using an LLM has been stored, and the processor 1310 that executes the program. The processor 1310 generates modified information on the approval of flight plan information or the flight plan information that is included in the flight information.

The processor 1310 determines whether an air mobility corresponds to the subject of evasion by considering a priority rule.

The processor 1310 considers the priority rule including at least any one of the importance of a flight mission, the amount of remaining battery power, a flight speed, and a communication state, generates an alternative flight path including at least any one of altitude, direction, and speed when determining that the air mobility corresponds to the subject of evasion, and transmits modified information.

The communication device 1320 may transmit or receive a wired signal or a wireless signal.

Furthermore, the method according to an embodiment of the present disclosure may be implemented in the form of a program instruction which may be executed through various computer means, and may be recorded on a computer-readable medium.

The computer-readable medium may include a program instruction, a data file, and a data structure alone or in combination. A program instruction recorded on the computer-readable medium may be specially designed and constructed for an embodiment of the present disclosure or may be known and available to those skilled in the computer software field. The computer-readable medium may include a hardware device configured to store and execute the program instruction. For example, the computer-readable medium may include magnetic media such as a hard disk, a floppy disk, and a magnetic tape, optical media such as CD-ROM and a DVD, magneto-optical media such as a floptical disk, ROM, RAM, and flash memory. The program instruction may include not only a machine code produced by a compiler, but a high-level language code capable of being executed by a computer through an interpreter.

The embodiments of the present disclosure have been described in detail, but the scope of rights of the present disclosure is not limited thereto. A variety of modifications and changes made by those skilled in the art using the basic concept of the present disclosure defined in the appended claims are also included in the scope of rights of the present disclosure.

What is claimed is:

1. A system using a large language model (LLM) for aerial mobility means comprising:
an air mobility configured to transmit flight information; and
a server configured to receive the flight information, determine whether a collision risk is present in the air mobility by performing analysis using an LLM, and transmit order information based on results of the determination.

2. The system of claim 1, wherein the air mobility transmits the flight information comprising trajectory information comprising latitude, longitude, altitude, and time information and flight plan information.

3. The system of claim 2, wherein the air mobility transmits the flight plan information comprising a planned altitude, direction, and speed.

4. The system of claim 1, wherein the air mobility transmits flight information of another mobility, which is received through direct communication between air mobilities.

5. The system of claim 1, wherein the server comprises:
a prompt conversion unit configured to perform prompt engineering based on the flight information,
a large language model (LLM) processing unit configured to determine whether a collision possibility is present by providing a generated prompt to the LLM,
a collision evasion decision unit configured to determine a subject of evasion based on results of a determination of the LLM,
an evasion path calculation unit configured to calculate a path for the determined subject of evasion, and
an order transmission unit configured to transmit the path to the air mobility.

6. The system of claim 5, wherein the prompt conversion unit converts the flight information into a natural language sentence having a contextual structure, which is understandable by the LLM.

7. The system of claim 5, wherein the LLM processing unit determines a suitability of a flight plan by previously learning aviation safety regulations.

8. The system of claim 5, wherein the collision evasion decision unit determines the subject of evasion by considering a priority rule.

9. The system of claim 8, wherein the collision evasion decision unit calculates evasion priority by considering at least any one of importance of a flight mission, a remaining battery capacity, a flight speed, and a communication state.

10. The system of claim 5, wherein the evasion path calculation unit generates an alternative flight path comprising at least any one of altitude, direction, and speed based on a minimum risk maneuvering strategy.

11. The system of claim 5, wherein the order transmission unit transmits information that approves a flight plan included in the flight information received from the air mobility or adjustment information on the flight path.

12. A method using a large language model (LLM) for aerial mobility means, the method performed by a system using an LLM for aerial mobility means comprising:
(a) receiving flight information from an air mobility;
(b) performing prompt engineering based on the flight information and generating a query for an LLM;
(c) determining an evasion of the air mobility by using the LLM; and
(d) calculating an evasion path of the air mobility and transmitting orders.

13. The method of claim 12, wherein the step (a) comprises receiving trajectory information comprising latitude, longitude, altitude, and time information.

14. The method of claim 12, wherein the step (b) comprises converting the flight information into a natural language sentence.

15. The method of claim 12, wherein the step (c) comprises:
determining a suitability of the flight information based on results of learning of aviation safety regulations, and
determining the air mobility to be a subject of evasion by considering a priority rule.

16. The method of claim 15, wherein the step (c) comprises determining the evasion of the air mobility by considering the priority rule comprising at least any one of importance of a flight mission, an amount of remaining battery power, a flight speed, and a communication state.

17. The method of claim 12, wherein the step (d) comprises calculating an evasion path comprising at least any one of altitude, direction, and speed based on a minimum risk maneuvering strategy.

18. An apparatus using a large language model (LLM) for aerial mobility means, the apparatus comprising:
an input interface device configured to receive flight information of an air mobility;
memory in which a program that determines whether a collision possibility is present by analyzing the flight information by using an LLM has been stored; and
a processor configured to execute the program,
wherein the processor generates modified information on an approval of flight plan information included in the flight information or the flight plan information.

19. The apparatus of claim 18, wherein the processor determines whether the air mobility corresponds to a subject of evasion by considering a priority rule.

20. The apparatus of claim 19, wherein the processor generates an alternative flight path comprising at least any one of altitude, a direction, and a speed when the air mobility corresponds to the subject of evasion by considering the priority rule comprising at least any one of importance of a flight mission, an amount of remaining battery power, a flight speed, and a communication state and transmits the modified information.
